(19) United States
(12) Patent Application Publication
(10) Pub. No.: US 2007/0156825 A1
(43) Pub. Date: Jul. 5, 2007

(54) Electronic Mail (Email) System Providing Enhanced Message Retrieval from Email Storage Server and Related Methods

(75) Inventors: Steven J. McCarthy, Bellevue, WA (US); Suryanarayana Murthy Gorty, Redmond, WA (US); David Jaray Hanson, Snoqualmie, WA (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: TEAMON SYSTEMS, INC., Issaquah, WA (US)

(21) Appl. No.: 11/559,533

(22) Filed: Nov. 14, 2006

Related U.S. Application Data
(60) Provisional application No. 60/756,018, filed on Jan. 4, 2006.

(51) Int. Cl. G06F 15/16

(52) U.S. Cl. 709/206

(57) ABSTRACT

An electronic mail (email) system may include at least one mobile wireless communications device, and at least one email storage server for storing emails. The at least one email storage server may also be for associating with each email a unique identification (UID) value and a water mark value that sequentially changes for each email. The system may further include an email relay server for cooperating with the at least one email storage server for selecting emails from the at least one email storage server based upon the water mark values, and forwarding selected emails to the at least one wireless communications device based upon the UID values of the selected emails.

### CROSS-REFERENCE TO RELATED APPLICATIONS

This application claims the benefit of U.S. Provisional Application No. 60/756,018, filed Jan. 4, 2006, which is hereby incorporated herein in its entirety by reference.

### FIELD OF THE INVENTION

The present invention relates to the field of communications systems, and, more particularly, to electronic mail (email) communications systems and related methods.

### BACKGROUND

Electronic mail (email) has become an integral part of business and personal communications. As such, many users have multiple email accounts for work and home use. Moreover, with the increased availability of mobile cellular and wireless local area network (LAN) devices that can send an receive emails, many users wirelessly access emails stored in source mailboxes of different email storage servers (e.g., corporate email storage server, Yahoo, Hotmail, AOL, Google (i.e., Gmail), etc.).

Mail user agents (MUAs) are applications which use a technique called polling to relay messages from the mail server to the mail program at a user's computer or mobile wireless communications device. An MUA is a program running either on a user's personal computing device (mobile or stationary), or on a shared email relay server that checks for new mail on behalf of a multitude of such users. More particularly, polling is the retrieval of incoming messages from other users at the mail server and delivery of these messages to the user's mailbox.

An email relay server may be particularly appropriate where emails need to be relayed to wireless communications devices. This is because having a wireless communications device, such as a cellular device, polling an email server(s) via a cellular network may result in increased usage charges for users as well as consumption of network resources. Thus, some email systems use an email relay server that checks one or more electronic user mailboxes for a given user, and provides a notification message to the user's wireless communications device when a new email message(s) is available. The wireless communications device then polls the email relay server for the new email message(s), which therefore reduces the amount of wireless communications resources consumed by the device.

As email storage systems become more sophisticated and provide more features to users, it can become more challenging for MUAs to poll such systems for email messages. By way of example, Gmail is an email service provided by Google which uses Google's search technology to automatically organize and archive email messages so they can be found again as needed. Moreover, Gmail provides more than 2,500 megabytes (2.5 gigabytes) of storage per user. As a result, a user is able to store an extremely large number of emails in his or her Gmail account. Another feature of the Gmail system is the way in which it provides access to a user's email. For example, Gmail automatically groups an email and the replies to it in a window as a “conversation,” which allows the user to view the message in its context.

While the Gmail system supports MUA access using the POP3 email retrieval protocol, the potential volume of emails stored in a user's Gmail account can make POP3 email retrieval problematic. That is, during a typical POP3 access operation an MUA may request a POP3 server to provide a list of all available (i.e., saved) messages, and it can compare the unique identifiers (UIDs) associated with the emails in the list with a list of UIDs it has already retrieved to determine which emails are new. However, with a list of several gigabytes worth of email messages, such a comparison operation may become untenable when mail checks are performed on a fairly frequent basis. This may be particularly so for an email relay sever that may be polling for messages for hundreds or thousands of users at frequent intervals from multiple email storage servers.

Another challenge created by the Gmail system is that the unique window feature for grouping emails in a conversation may affect the way a POP3 server accesses the emails. That is, a typical “TOP” POP3 command may not advance the window past the oldest archived messages in a conversation, meaning that the MUA might not be informed of new email messages in the same conversation but outside the defined window. Still another challenge is that once a given email is retrieved from the Gmail system using a retrieve POP3 command (RETR), the email may not be accessible for subsequent retrievals. This may be problematic if an email relay server needs to forward a copy of the email, for example, if the email relay server does not keep copies of relayed emails.

Certain email server applications have features that may provide some assistance in email retrieval operations. For example, Outlook Web Access (OWA) servers (i.e., versions 2000 and above) allow querying for messages that have a receive date greater than a specified date. In addition, Internet Message Access Protocol (IMAP) servers assign UIDs to emails in an increasing fashion. Yet, new email retrieval techniques may be desired for retrieving messages from advanced email systems such as the Gmail system.

### BRIEF DESCRIPTION OF THE DRAWINGS

FIG. 1 is a schematic block diagram of an email system in accordance with one exemplary embodiment.

FIGS. 2 and 3 are flow diagrams illustrating email method aspects in accordance with exemplary embodiments.

FIG. 4 is a schematic block diagram illustrating exemplary components of the mobile wireless communications device of the system of FIG. 1.

### DETAILED DESCRIPTION

The present description is made with reference to the accompanying drawings, in which preferred embodiments are shown. However, many different embodiments may be used, and thus the description should not be construed as limited to the embodiments set forth herein. Rather, these embodiments are provided so that this disclosure will be thorough and complete. Like numbers refer to like elements throughout, and prime notation is used to indicate similar elements or steps in different embodiments.

Generally speaking, an electronic mail (email) system is disclosed herein which may include at least one mobile wireless communications device, and at least one email storage server for storing emails. The at least one email storage server may also be for associating with each email a unique identification (UID) value and a water mark value that sequentially changes for each email. The system may further include an email relay server for cooperating with the at least one email storage server for selecting emails from the at least one email storage server based upon the water mark values, and forwarding selected emails to the at least one wireless communications device based upon the UID values of the selected emails.

More particularly, a last selected and forwarded email may define a high water mark value, and the email relay server may select new emails from the at least one email server to forward based upon the high water mark value. In addition, the water mark values may be time stamps associated with a time of receipt of emails by the at least one email storage server, as well as an incrementally increasing series of numbers. The UIDs, however, may not necessarily be in sequential order in all embodiments.

Furthermore, the email relay server may retrieve from the at least one email storage server a previously viewed indicator for each email. As such, the email relay server may cooperate with the mobile wireless communications device to indicate previously viewed emails at the wireless communications device based upon the previously viewed indicators. Additionally, the email relay server may further instruct the at least one email storage server to make forwarded emails available for later retrieval.

An electronic mail (email) relay server may be for forwarding emails stored on at least one email storage server to at least one mobile wireless communications device, where the at least one email storage server associates with each email a UID value and a water mark value that sequentially changes for each email. More particularly, the email relay server may include a selection module for cooperating with the at least one email storage server for selecting emails from the at least one email storage server based upon the water mark values, and a forwarding module for cooperating with the at least one email storage server for forwarding selected emails to the at least one wireless communications device based upon the UID values of the selected emails.

An email method may include storing emails on at least one email storage server, and associating with each email a unique identification (UID) value and a water mark value that sequentially changes for each email. The method may further include selecting emails from the at least one email storage server based upon the water mark values, and forwarding selected emails to at least one wireless communications device based upon the UID values of the selected emails.

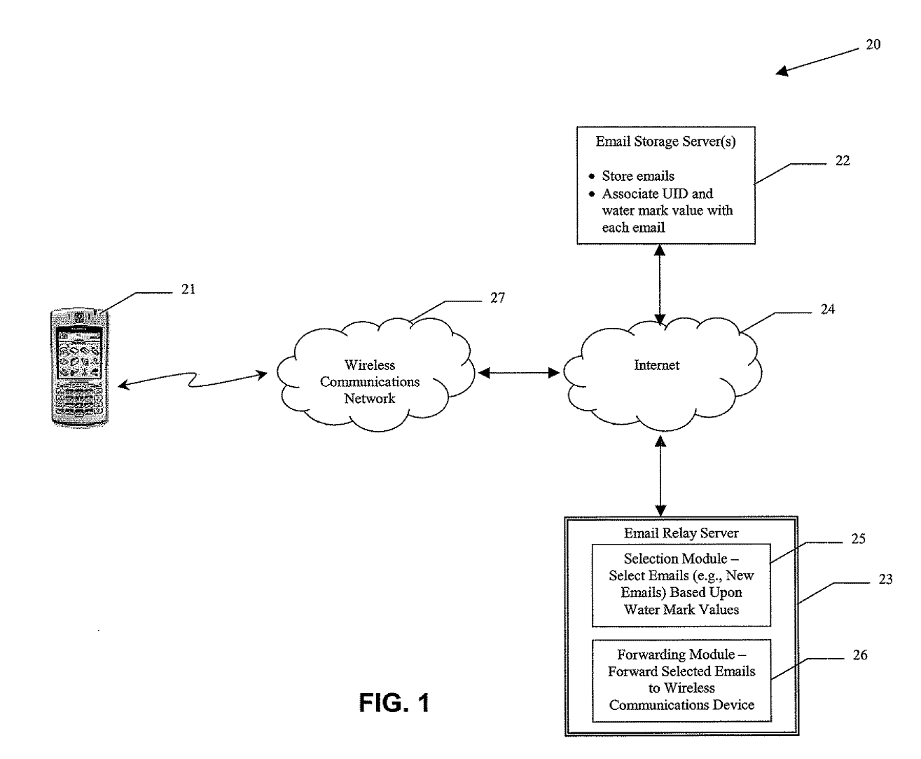

Referring now initially to FIG. 1, an electronic mail (email) system 20 illustratively includes one or more mobile wireless communications devices 21, such as a cellular and/or wireless local area network (LAN) device, for example. The system further 20 illustratively includes one or more email storage servers 22 for storing emails for users based upon respective user email accounts and associated email addresses. By way of example, the email storage server 22 may be part of an Internet service provider (ISP) or corporate email system, for example. As further noted above, such email storage servers typically associate with each email a unique identification (UID) value that is used for identifying the email to allow various operations to be performed relative thereto, such as retrieval for forwarding to another destination.

Yet, as also discussed above, it can be difficult to identify emails from among the UIDs associated therewith on some systems, as in some circumstances UIDs can be repeated, they can be assigned is a non-sequential fashion (e.g., based upon a hash of subject, sender, etc., fields), or there may be several Gigabytes of emails stored in a user's account (as is possible with Gmail, for example). Accordingly, the email storage server 22 also preferably generates an additional value for each email it receives, namely a water mark value that sequentially changes for each new email. By way of example, the water mark value may be a time stamp or an incrementally increasing series of numbers, as will be discussed further below. This may be accomplished by providing an additional module (e.g., implemented in software) at the email storage server 22 that assigns the water mark values, and cooperates with an email relay server 23 to select and forward new emails to the wireless communications device 21, as will be discussed further below.

The system 20 also illustratively includes the email relay server 23 which is for forwarding emails stored on the email storage server to wireless communications devices 21 for respective users, as will be appreciated by those skilled in the art. In the illustrated embodiment, the email relay server communicates with the email storage server 22 via a wide area network 24, here the Internet, for selecting emails to forward from the email storage server 22 based upon the water mark values. More particularly, the email relay server 23 selects new emails (i.e., emails that have not already been forwarded to the wireless communications device 21) based upon the water mark values.

More particularly, a last selected and forwarded email may define a high water mark value. That is, since the water mark values are sequentially changing, the last water mark value (i.e., the water mark value assigned to the last email “seen” by the email relay server 23 will have the highest (in the case of an ascending or increasing sequence) water mark value of all the emails seen by the email relay server. Thus, the email relay server 23 selects new emails from the email storage server 22 to forward based upon the high water mark value, which the email relay server preferably updates and stores each time is forwards new messages to the wireless communications device 21.

The email relay server 23 may run a mail user agent (MUA) application for performing the various selection and forwarding operations described herein. For purposes of the present description, the MUA may be conceptually considered as a selection module 25 that selects the emails to be forwarded to the wireless communications device 21 and otherwise interfaces with the email storage server 22, and a forwarding module 26 that forwards the selected emails to the wireless communications device and otherwise interfaces therewith. However, it will be appreciated that the various operations performed by the email relay server 23 and the MUA may be embodied using a combination of hardware and software components that may be distributed across multiple computing devices. The email relay server communicates with the wireless communications device 21 via the Internet 24 and a wireless communications network (e.g., a cellular network) 27, for example.

The email relay server 23 cooperates with the email storage server 22 for forwarding selected emails to the wireless communications device 21 based upon the UIDs of the selected emails. That is, the UID values are how the email relay server 23 identifies the emails to be forwarded to the wireless communications device 21, as will be appreciated by those skilled in the art, although this could potentially be done based upon the water mark values in some embodiments.

Further aspects of the invention will be understood with reference to an exemplary implementation thereof directed to an extension to the POP (e.g., POP3) email retrieval architecture. However, it should be noted that the techniques described herein may be used with email protocols other than POP3, as will be appreciated by those skilled in the art. Generally speaking, for requests in POP3 that would ordinarily be based on a sequence number, such as a list request, extension commands are instead implemented that are based on a high water mark. Moreover, a designation is made as to whether an email, once downloaded, remains accessible via the POP3 interface.

As noted above, email systems such as Gmail typically associate a unique identifier (UID) with each individual email that is received by the system. The POP3 protocol specifies that these UIDs should be unique, but it does not specify a particular format for the UIDs. In some cases, the UID may not necessarily be assigned sequentially or in ascending order to new emails, but rather may be formulated based upon the characteristics of the email (e.g., its origin, send date, receive date, etc.). As a result, in some instances is it is possible that a UID may be unintentionally repeated, and they may not necessarily be assigned in ascending order.

In one embodiment, the email hosting system (e.g., Gmail) will assign a separate water mark value to each email in addition to its UID. The water mark may be an ascending number, with each new water mark being higher than the last. That is, the water mark is preferably an ever-increasing, numeric indicator that is unique for each UID. By way of example, the water mark could be sequentially assigned to each new email received (e.g., 1000, 1001, 1002, etc.). Another approach may be that the water mark may be a time stamp associated with the date and time an email is received, which by its nature will always be an ascending number, as will be appreciated by those skilled in the art.

Accordingly, when an MUA requests a list of available emails, for example, the response provided by the POP3 server of the email host system will include the UIDs of the emails as well as their respective corresponding watermarks. The MUA can therefore keep a record of the water mark associated with the last email it retrieved (i.e., the “high water mark”), and when it next requests a list of available messages it may advantageously request only emails having a water mark higher than the high water mark, i.e., new emails.

An exemplary POP3 list request to an email host system's POP 3 server and corresponding response are provided below in Example 1. In this example, a command “UIDLSINCE” is used to request the UID, water mark, size, and a “seen” indicator for each message after the specified high water mark. Thus, in Example 1, 1000 is the value of the high water mark, and the MUA is requesting a list of all email UIDs, the size of the emails, and an indication as to whether the email has been seen (1) or not (0) after the email with the high water mark.

### EXAMPLE 1

Request from MUA:
UIDLSINCE 1000 SIZE SEEN
Response from POP3 Server:

| (UID) | (WM) | (Size) | (Seen) |
|---|---|---|---|
| 234567890 | 1001 | 2000 | 0 |
| 234567891 | 1002 | 2200 | 1 |
| 234567892 | 1003 | 500 | 0 |

In response, the POP3 server of the host email system (i.e., the email storage server 22) indicates that three new emails are available (i.e., 234567890, 234567891, 234567892), along with their respective water marks (i.e., 1001, 1002, 1003), sizes (in bytes) and the seen (i.e., previously viewed) indication. In particular, the seen indicator indicates whether the email has been seen or viewed through the host email account (e.g., through a Gmail Internet or Web mail interface). This advantageously allows the MUA to indicate for the user on his/her mobile wireless communications device, for example, that the email has already been viewed. UIDs are preferably returned in chronological order with the newest message returned last, although this need not by the case in all embodiments.

However, the advantage of using a separate water mark for each email is that the water mark likely will never be accidentally repeated, and it also likely ensures that the email count will always be ascending so that the MUA and POP3 server can readily identify new mail not yet retrieved by the MUA. Moreover, the host email system does not have to change the way in which it assigns UIDs. In addition, special values of water marks may be used to perform certain operations, such as a water mark or “0” to indicate “before all mail in the mailbox,” for example.

The above-described approach may be particularly advantageous given that interruptions occasionally occur during Internet data transfers which may cause only a partial listing of emails to be received from a POP3 server, for example. In such cases, the water mark value associated with the last email UID received becomes the high water mark, and a subsequent request for a list of new emails need only include emails after the high water mark, rather than repeating the entire list of emails that was only partially received.

Once the MUA has the list of new email UIDs stored on the host email system, it may then retrieve desired emails to forward to a user's mobile wireless communications device 21, etc., using an extension of a POP3 GET-type request and the UIDs associated with the new emails. An exemplary format for the GET request would be “RETRUID 234567890” to retrieve the first of the new emails listed in Example 1 above. Furthermore, an additional command may be appended to the GET request to instruct the POP3 server to make the requested email(s) available for later retrieval as well to allow for future forwarding or other operations, as discussed above.

The above-described approach may provide desired optimization for mailboxes that offer Web mail as most often they can return a message timestamp, for example, in an efficient query along with the UID of the message. With this approach, the email relay server 23 stores the timestamp of the most recent message along with its UID. Next time it polls that mailbox, all messages that have a timestamp newer than the stored-timestamp are determined to be new. As such, the email relay server 23 advantageously need not store an entire UID list from the email storage server 22, and instead may store only the most recent high water mark along with its associated UID. This results in a reduction in size of the message-UID database at the email relay server 23, as well as less bandwidth utilization between the email storage server 22 and the email relay server from having to send large lists of UIDs from several subscribers numerous times in a day.

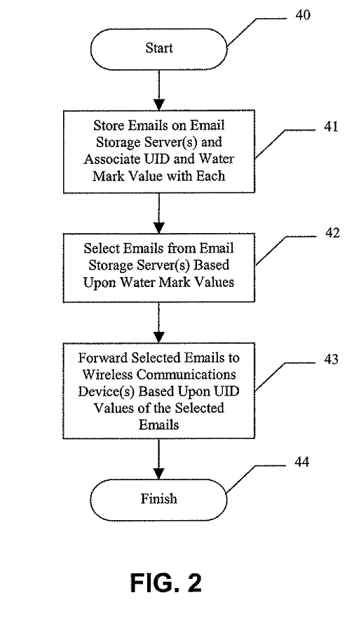

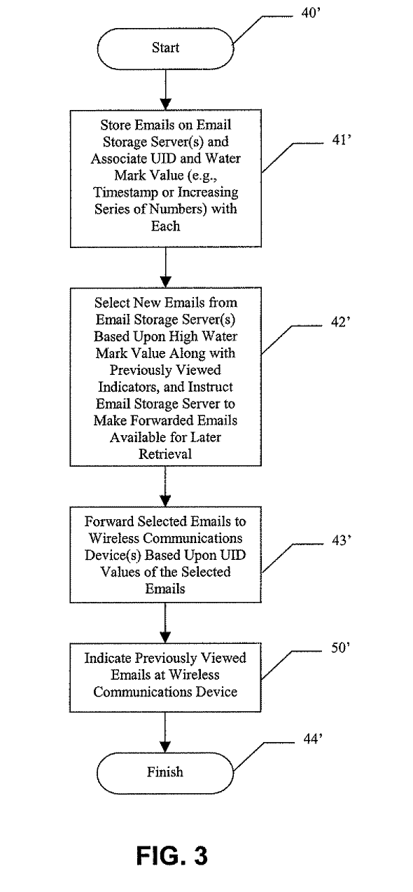

Turning now additionally to FIGS. 2 and 3, related email method aspects may include, beginning at Block 40, storing emails on at least one email storage server 22, and associating with each email a unique identification (UID) value and a water mark value that sequentially changes for each email, at Block 41. As noted above, the water mark values may be timestamp values, an incrementally increasing series of numbers, etc. (Block 41′). The method further illustratively includes selecting emails from the at least one email storage server 22 based upon the water mark values, at Block 42, and forwarding selected emails to at least one wireless communications device 21 based upon the UID values of the selected emails, at Block 43, thus concluding the method illustrated in FIG. 2 (Block 44). Again, new emails may be selected based upon a high water mark, and an instruction may also be provided to the email storage server 22 to make the selected email(s) available for later forwarding or other operations, as discussed further above (Block 42′). Another optional step is to indicate at the wireless communications device previously viewed emails, at Block 50′, as also described further above.

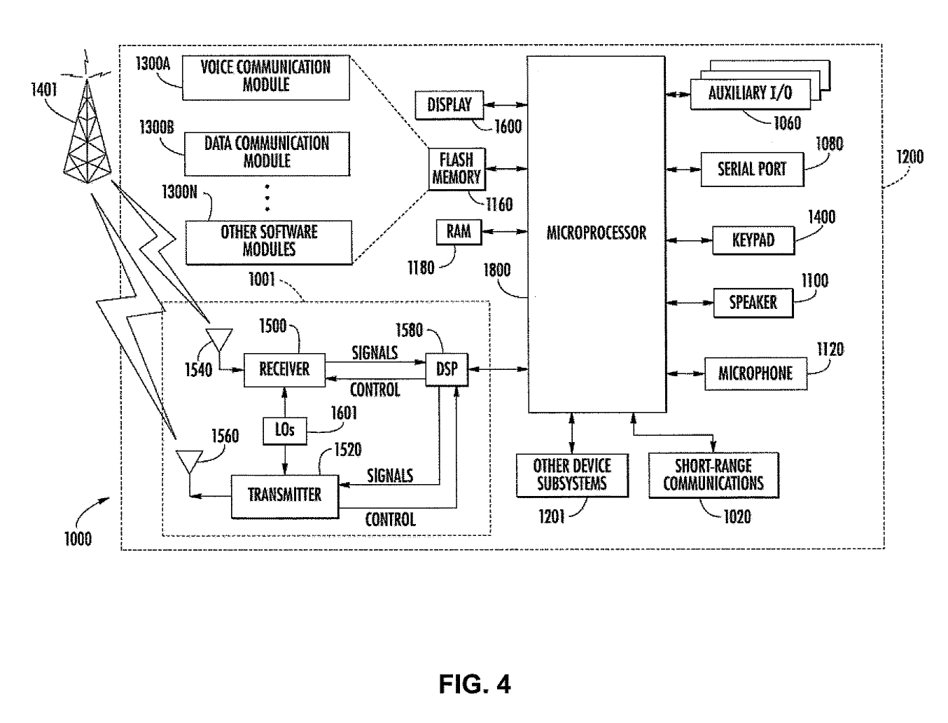

Exemplary components of a hand-held mobile wireless communications device 1000 that may be used in the above-described system 20 are further described in the example below with reference to FIG. 4. The device 1000 illustratively includes a housing 1200, a keypad 1400 and an output device 1600. The output device shown is a display 1600, which is preferably a full graphic LCD. Other types of output devices may alternatively be utilized. A processing device 1800 is contained within the housing 1200 and is coupled between the keypad 1400 and the display 1600. The processing device 1800 controls the operation of the display 1600, as well as the overall operation of the mobile device 1000, in response to actuation of keys on the keypad 1400 by the user.

The housing 1200 may be elongated vertically, or may take on other sizes and shapes (including clamshell housing structures). The keypad may include a mode selection key, or other hardware or software for switching between text entry and telephony entry.

In addition to the processing device 1800, other parts of the mobile device 1000 are shown schematically in FIG. 4. These include a communications subsystem 1001; a short-range communications subsystem 1020; the keypad 1400 and the display 1600, along with other input/output devices 1060, 1080, 1100 and 1120; as well as memory devices 1160, 1180 and various other device subsystems 1201. The mobile device 1000 is preferably a two-way RF communications device having voice and data communications capabilities. In addition, the mobile device 1000 preferably has the capability to communicate with other computer systems via the Internet.

Operating system software executed by the processing device 1800 is preferably stored in a persistent store, such as the flash memory 1160, but may be stored in other types of memory devices, such as a read only memory (ROM) or similar storage element. In addition, system software, specific device applications, or parts thereof, may be temporarily loaded into a volatile store, such as the random access memory (RAM) 1180. Communications signals received by the mobile device may also be stored in the RAM 1180.

The processing device 1800, in addition to its operating system functions, enables execution of software applications 1300A-1300N on the device 1000. A predetermined set of applications that control basic device operations, such as data and voice communications 1300A and 1300B, may be installed on the device 1000 during manufacture. In addition, a personal information manager (PIM) application may be installed during manufacture. The PIM is preferably capable of organizing and managing data items, such as e-mail, calendar events, voice mails, appointments, and task items. The PIM application is also preferably capable of sending and receiving data items via a wireless network 1401. Preferably, the PIM data items are seamlessly integrated, synchronized and updated via the wireless network 1401 with the device user's corresponding data items stored or associated with a host computer system.

Communication functions, including data and voice communications, are performed through the communications subsystem 1001, and possibly through the short-range communications subsystem. The communications subsystem 1001 includes a receiver 1500, a transmitter 1520, and one or more antennas 1540 and 1560. In addition, the communications subsystem 1001 also includes a processing module, such as a digital signal processor (DSP) 1580, and local oscillators (LOs) 1601. The specific design and implementation of the communications subsystem 1001 is dependent upon the communications network in which the mobile device 1000 is intended to operate. For example, a mobile device 1000 may include a communications subsystem 1001 designed to operate with the Mobitex™, Data TAC™ or General Packet Radio Service (GPRS) mobile data communications networks, and also designed to operate with any of a variety of voice communications networks, such as AMPS, TDMA, CDMA, WCDMA, PCS, GSM, EDGE, etc. Other types of data and voice networks, both separate and integrated, may also be utilized with the mobile device 1000. The mobile device 1000 may also be compliant with other communications standards such as 3GSM, 3GPP, UMTS, etc.

Network access requirements vary depending upon the type of communication system. For example, in the Mobitex and DataTAC networks, mobile devices are registered on the network using a unique personal identification number or PIN associated with each device. In GPRS networks, however, network access is associated with a subscriber or user of a device. A GPRS device therefore requires a subscriber identity module, commonly referred to as a SIN card, in order to operate on a GPRS network.

When required network registration or activation procedures have been completed, the mobile device 1000 may send and receive communications signals over the communication network 1401. Signals received from the communications network 1401 by the antenna 1540 are routed to the receiver 1500, which provides for signal amplification, frequency down conversion, filtering, channel selection, etc., and may also provide analog to digital conversion. Analog-to-digital conversion of the received signal allows the DSP 1580 to perform more complex communications functions, such as demodulation and decoding. In a similar manner, signals to be transmitted to the network 1401 are processed (e.g. modulated and encoded) by the DSP 1580 and are then provided to the transmitter 1520 for digital to analog conversion, frequency up conversion, filtering, amplification and transmission to the communication network 1401 (or networks) via the antenna 1560.

In addition to processing communications signals, the DSP 1580 provides for control of the receiver 1500 and the transmitter 1520. For example, gains applied to communications signals in the receiver 1500 and transmitter 1520 may be adaptively controlled through automatic gain control algorithms implemented in the DSP 1580.

In a data communications mode, a received signal, such as a text message or web page download, is processed by the communications subsystem 1001 and is input to the processing device 1800. The received signal is then further processed by the processing device 1800 for an output to the display 1600, or alternatively to some other auxiliary I/O device 1060. A device user may also compose data items, such as e-mail messages, using the keypad 1400 and/or some other auxiliary I/O device 1060, such as a touchpad, a rocker switch, a thumb-wheel, or some other type of input device. The composed data items may then be transmitted over the communications network 1401 via the communications subsystem 1001.

In a voice communications mode, overall operation of the device is substantially similar to the data communications mode, except that received signals are output to a speaker 1100, and signals for transmission are generated by a microphone 1120. Alternative voice or audio I/O subsystems, such as a voice message recording subsystem, may also be implemented on the device 1000. In addition, the display 1600 may also be utilized in voice communications mode, for example to display the identity of a calling party, the duration of a voice call, or other voice call related information.

The short-range communications subsystem enables communication between the mobile device 1000 and other proximate systems or devices, which need not necessarily be similar devices. For example, the short-range communications subsystem may include an infrared device and associated circuits and components, or a Bluetooth™ communications module to provide for communication with similarly-enabled systems and devices.

Many modifications and other embodiments will come to the mind of one skilled in the art having the benefit of the teachings presented in the foregoing descriptions and the associated drawings. Therefore, it is understood that various modifications and embodiments are intended to be included within the scope of the appended claims.

That which is claimed is:

1. An electronic mail (email) system comprising:
at least one mobile wireless communications device;
at least one email storage server for storing emails, and associating with each email a unique identification (UID) value and a water mark value that sequentially changes for each email; and
an email relay server for cooperating with said at least one email storage server for selecting emails from said at least one email storage server based upon the water mark values, and forwarding selected emails to said at least one wireless communications device based upon the UID values of the selected emails.

2. The email system of claim 1 wherein a last selected and forwarded email defines a high water mark value; and wherein said email relay server selects new emails from said at least one email storage server to forward based upon the high water mark value.

3. The email system of claim 1 wherein the water mark values comprise time stamps associated with a time of receipt of emails by said at least one email storage server.

4. The email system of claim 1 wherein the water mark values comprise an incrementally increasing series of numbers.

5. The email system of claim 1 wherein the UIDs are not in sequential order.

6. The email system of claim 1 wherein said email relay server retrieves from said at least one email storage server a previously viewed indicator for each email.

7. The email system of claim 6 wherein said email relay server cooperates with said at least one mobile wireless communications device to indicate previously viewed emails at the at least one wireless communications device based upon the previously viewed indicators.

8. The email system of claim 1 wherein said email relay server further instructs said at least one email storage server to make forwarded emails available for later retrieval.

9. An electronic mail (email) relay server for forwarding emails stored on at least one email storage server to at least one mobile wireless communications device, the at least one email storage server associating with each email a unique identification (UID) value and a water mark value that sequentially changes for each email, the email relay server comprising:
a selection module for cooperating with said at least one email storage server for selecting emails from the at least one email storage server based upon the water mark values; and
a forwarding module for cooperating with said at least one email storage server for forwarding selected emails to the at least one wireless communications device based upon the UID values of the selected emails.

10. The email relay server of claim 9 wherein a last selected and forwarded email defines a high water mark value; and wherein said selection module selects new emails from the at least one email storage server to forward based upon the high water mark value.

11. The email relay server of claim 9 wherein the water mark values comprise time stamps associated with a time of receipt of emails by said at least one email storage server.

12. The email relay server of claim 9 wherein the water mark values comprise an incrementally increasing series of numbers.

13. An electronic mail (email) method comprising:
storing emails on at least one email storage server, and associating with each email a unique identification (UID) value and a water mark value that sequentially changes for each email;
selecting emails from the at least one email storage server based upon the water mark values; and
forwarding selected emails to at least one wireless communications device based upon the UID values of the selected emails.

14. The method of claim 13 wherein a last selected and forwarded email defines a high water mark value; and wherein selecting comprises selecting new emails from the at least one email server to forward based upon the high water mark value.

15. The method of claim 13 wherein the water mark values comprise time stamps associated with a time of receipt of emails by the at least one email storage server.

16. The method of claim 13 wherein the water mark values comprise an incrementally increasing series of numbers.

17. The method of claim 13 wherein the UIDs are not in sequential order.

18. The method of claim 13 further comprising retrieving from the at least one email storage server a previously viewed indicator for each email.

19. The method of claim 18 further comprising indicating previously viewed emails at the at least one wireless communications device based upon the previously viewed indicators.

20. The method of claim 13 further comprising instructing the at least one email storage server to make forwarded emails available for later retrieval.
